(19) United States
(12) Patent Application Publication
(10) Pub. No.: US 2025/0047159 A1
(43) Pub. Date: Feb. 6, 2025

(54) Sliding Cover for a Salient-Pole Rotor With Bulkhead, Salient-Pole Rotor, and Electric Machine

(71) Applicant: Bayerische Motoren Werke Aktiengesellschaft, Muenchen (DE)

(72) Inventors: Joachim MAERZ, Holzkirchen (DE); Robert SCHMIDT, Muenchen (DE)

(21) Appl. No.: 18/719,455

(22) PCT Filed: Nov. 17, 2022
(86) PCT No.: PCT/EP2022/082225

§ 371 Date: Jun. 13, 2024

(30) Foreign Application Priority Data
Dec. 16, 2021 (DE) 10 2021 133 424.1

(51) Int. Cl. H02K 3/487

(52) U.S. Cl. CPC H02K 3/487

(57) ABSTRACT

A sliding cover for a salient-pole rotor of an electric machine for closing a groove formed between two adjacent salient poles of the salient-pole rotor, having a groove-closing wedge extending axially and in the peripheral direction, for closing the groove and supported on pole shoes of the adjacent salient poles, the groove-closing wedge having an inner side facing the groove and an outer side facing an air gap of the electric machine, and at least one bulkhead arranged on the groove-closing wedge and extending radially starting from the outer side of the groove-closing wedge, for reducing a power-loss-increasing axial flow along the sliding cover in the air gap of the electric machine.

### BACKGROUND AND SUMMARY

The invention relates to a sliding cover for a salient-pole rotor of an electric machine, for closing a groove formed between two adjacent salient poles of the salient-pole rotor. The sliding cover has a groove closure wedge, extending axially and in the circumferential direction, for closing the groove and being supported on pole shoes of the adjacent salient poles, wherein the groove closure wedge has an internal side facing the groove, and an external side facing an air gap of the electric machine. The invention moreover relates to a salient-pole rotor and to an electric machine.

The interest is presently focused on electric machines which can be used, for example, as a machine for driving electrified motor vehicles, thus electric vehicles or hybrid vehicles. Such electric machines usually have a stationary stator with energizable stator windings, and a rotor which is mounted so as to be rotatable relative to the stator and has magnetic field-generating components, for example energizable rotor windings. In a rotor of a salient-pole construction mode, these rotor windings can be wound about salient poles, or rotor poles, of a rotor core of the rotor. Grooves, or pole gaps, are formed between the salient poles.

The salient-pole rotor typically has a potting compound which, for example for reasons of stability, is filled into the pole gaps. In order to seal the rotor axially and radially in relation to leaking potting compound, the salient-pole rotor is secured by means of sliding covers which are usually composed of a groove closure wedge. These groove closure wedges are supported on pole shoes of two adjacent salient poles, closing the grooves in the process. A non-cylindrical external face of the salient-pole rotor may result owing to the geometric shape of the pole shoes and of the sliding covers. On account of this non-cylindrical external face, a significantly increased axial flow arises along the sliding covers in an air gap formed between the salient-pole rotor and the stator, as a result of which friction losses of the electric machine increase, in particular at very high circumferential speeds.

It is an object of the present invention to provide a solution by means of which friction losses in the air gap of an electric machine can be reduced.

This object is achieved according to the invention by a sliding cover, a salient-pole rotor and an electric machine having the features according to the respective independent patent claims. Advantageous embodiments of the invention are the subject matter of the dependent patent claims, of the description, and of the figures.

A sliding cover according to the invention for a salient-pole rotor of an electric machine serves to close a groove formed between two adjacent salient poles of the salient-pole rotor. The sliding cover has a groove closure wedge, extending axially and in the circumferential direction, for closing the groove and being supported on the pole shoes of the adjacent salient poles, wherein the groove closure wedge has an internal side facing the groove, and an external side facing an air gap of the electric machine. Moreover, the sliding cover has at least one bulkhead which is disposed on the groove closure wedge and, proceeding from the external side of the groove closure wedge, extends radially so as to reduce a power loss-increasing axial flow along the sliding cover in the air gap of the electric machine.

The invention moreover includes a salient-pole rotor for an electric machine. The salient-pole rotor comprises magnetic field-generating components for forming a rotor magnetic field, a rotor core having salient poles, which are disposed at a mutual spacing while forming grooves, for holding the magnetic field-generating components, and at least one sliding cover according to the invention. An electric machine according to the invention comprises a stationary stator and a salient-pole rotor according to the invention, which is mounted so as to be rotatable relative to the stator. An air gap is formed between the salient-pole rotor and the stator. The electric machine is in particular an externally energized, or current-energized, internal rotor synchronous machine, so that the salient-pole rotor, hereunder referred to as rotor for short, has energizable rotor windings as the magnetic field-generating components. The rotor, for holding and conducting the rotor magnetic field of the magnetic field-generating components, has the rotor core which can be configured, for example, as a laminated core of axially stacked and mechanically connected electrical sheets.

Since the rotor is made in a salient-pole construction mode, salient poles are disposed on a ring-shaped rotor yoke of the rotor core so as to radially project therefrom and be mutually spaced apart in the circumferential direction. The salient poles have in each case a pole tooth, or pole body, disposed on the rotor yoke, and a pole shoe disposed on the pole tooth. An external side of the pole shoes that faces the air gap is curved, or convexly shaped, along the circumferential direction, and herein has a first curvature radius. Winding conductors, for example wires, of the rotor winding are wound about the pole teeth and are held on the pole teeth by the pole shoes. The grooves, or pole gaps, by way of which the winding conductors can be introduced and wound about the pole teeth, are formed between the salient poles.

Moreover, for each groove the rotor has one sliding cover for closing the groove. The sliding covers have in each case a groove closure wedge which is configured to be substantially T-shaped, for example, and to this end has a first web disposed in the groove which extends radially, and a second web which extends in the circumferential direction and closes an access opening to the groove. In the process, the second web is supported on the pole shoes of the adjacent salient poles. The groove closure wedge, on lateral regions which are mutually opposite in the circumferential direction, can have connecting elements for pushing together axially with pole shoe regions of the pole shoes that project in the circumferential direction. For example, the connecting elements can be configured as mutually communicating grooves and pins which can be pushed into one another axially so as to establish a form-fitting groove-and-tongue connection between the sliding cover and the pole shoes. The connecting elements of the groove closure wedge are formed on ends of the second web that are mutually opposite in the circumferential direction, for example.

The external side of the groove closure wedge herein, which is in particular formed by an upper side of the second web, has a second curvature radius which deviates from the first curvature radius of the pole shoes. For example, the external side of the groove closure wedge is curved inward so as to be concave. On account of these different curvature radii of the pole shoes and of the groove closure wedges, the external side of the salient-pole rotor has a corrugated shape which deviates from a cylindrical shape and has concavities in the region of the groove closure wedges and convexities in the region of the pole shoes. The concavities herein form axial flow ducts for an increased axial flow, or air flow, respectively. In comparison to the flow duct in the region of the convexities, this flow duct has a larger flow cross section, as a result of which friction losses of the electric machine are increased.

In order to reduce this air flow and thus the friction losses, the sliding covers have in each case at least one bulkhead which, proceeding from the external side of the respective groove closure wedge, projects radially outward. In particular, the sliding covers have in each case a plurality of plate-shaped bulkheads which are disposed so as to be axially spaced apart on the external side of the groove closure wedge. For example, the bulkheads can be disposed on the groove closure wedges at uniform spacings along an axial length of the groove closure spacings. The groove closure spacing and the at least one associated bulkhead are in particular integrally configured. To this end, the sliding cover is made as an injection-molded part from plastics material, for example. The bulkheads herein are in particular plate-shaped or disk-shaped closure elements which in terms of their width extend along the circumferential direction, and in terms of their height extends in the radial direction. A thickness of the bulkheads, which is oriented in the axial direction, herein is significantly smaller than the width and the height. As a result of the bulkheads, a surface of the sliding cover that faces the air gap is of a ribbed configuration. As a result of the bulkheads, the flow cross section of the flow duct is reduced in parts so as to reduce the axial air flow to the greatest possible extent.

In this way, axial air flows along the sliding covers in the air gap can be minimized in a simple manner by the bulkheads in such a way that the electric machine has minor friction losses even at high rotating speeds. Owing to the fact that the bulkheads are only formed as thin plate-shaped or disk-shaped closure elements, any increase in the weight of the sliding covers can be minimized.

An external periphery of the at least one bulkhead that faces the air gap preferably has a convexly curved shape. In particular, the external periphery of the at least one bulkhead and the external side of the pole shoes from a substantially circular external contour of the salient-pole rotor in the region of the bulkheads. As a result of the convexly curved external peripheries of the bulkheads, the non-cylindrical external face of the salient-pole rotor, which is caused by the external side of the groove closure wedges, in portions transitions to a circular external contour of the salient-pole rotor, so that the flow cross section of the air gap is homogeneous in the region of the bulkheads.

In a refinement of the invention, the at least one bulkhead, on lateral regions which are mutually opposite in the circumferential direction, has groove-type recesses for partially receiving pole shoe regions of the pole shoes that project in the circumferential direction. As a result, when the sliding cover is in the state disposed on the rotor core, the bulkhead in regions covers the pole shoe regions so as to establish the circular external contour of the salient-pole rotor.

The embodiments and their advantages proposed in the context of the sliding cover according to the invention apply in an analogous manner to the salient-pole rotor according to the invention and to the electric machine according to the invention.

Further features of the invention result from the claims, the figures and the description of the figures. The features and combinations of features mentioned above in the description and the features and combinations of features mentioned in the following text in the description of the figures and/or in the figures alone can be used not only in the respective specified combination, but rather also in other combinations or on their own.

The invention will now be explained in more detail by means of a preferred exemplary embodiment and with reference to the drawings.

### BRIEF DESCRIPTION OF THE DRAWINGS

FIG. 1 shows a schematic perspective illustration of a salient-pole rotor;

FIG. 2 shows a cross-sectional illustration of a fragment of an electric machine having the salient-pole rotor according to FIG. 1;

FIG. 3 shows an enlarged fragment in the region of a sliding cover of the salient-pole rotor according to FIG. 1; and

FIG. 4 shows a longitudinal sectional illustration of the electric machine.

### DETAILED DESCRIPTION OF THE DRAWINGS

Identical and functionally equivalent elements are provided with the same reference signs in the figures.

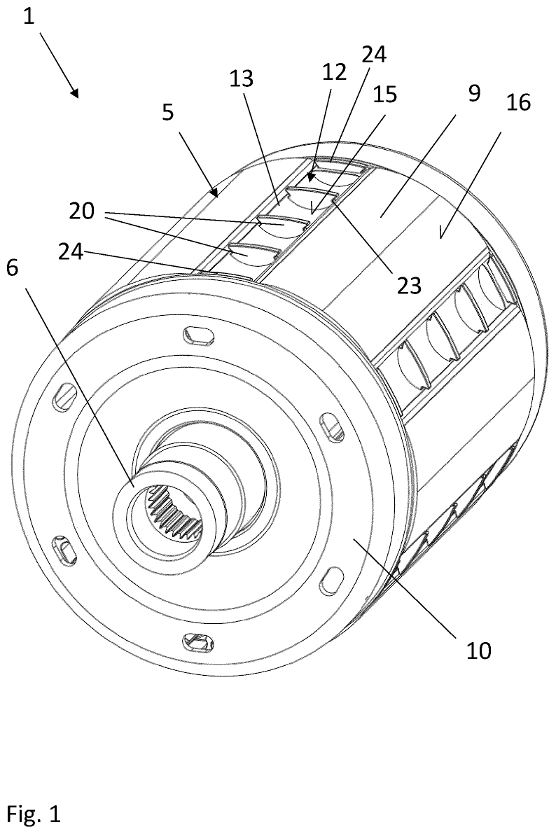

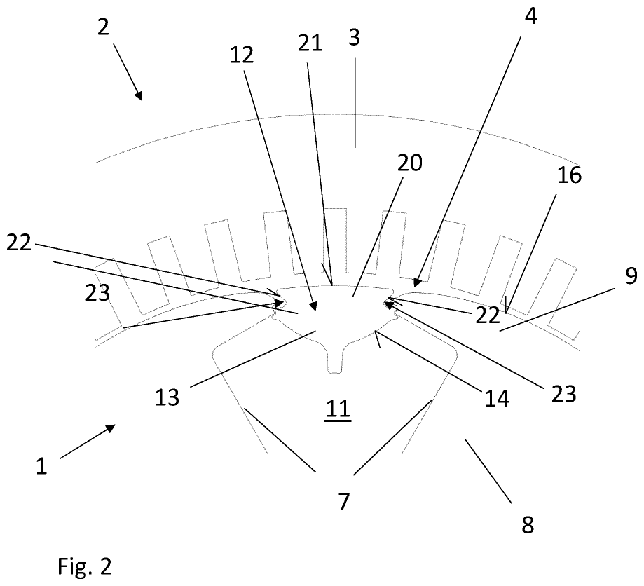

FIG. 1 shows a salient-pole rotor 1 for an electric machine 2, the cross section of the latter being shown in fragments in FIG. 2. The electric machine 2 can be used as a machine for driving an electrified motor vehicle, for example. The salient-pole rotor 1 herein is mounted so as to be rotatable relative to a stator 3 of the electric machine 2, wherein an air gap 4 is formed between the salient-pole rotor 1 and the stator 3. The salient-pole rotor 1 and the stator 3 here support magnetic field-generating components which are not shown herein and in an externally energized electric machine 2 can be configured as energizable windings or coils.

The salient-pole rotor 1 has a rotor core 5, for example in the form of a laminated core which for transmitting torque is co-rotationally connected to a shaft 6. The rotor core 5 has salient poles 7 which have in each case one pole tooth 8 and one pole shoe 9. Winding conductors of the respective winding can be wound about the pole tooth 8. These winding conductors form end windings on mutually opposite end sides of the rotor core 5. In order for the salient-pole rotor 1 to be stabilized, the latter moreover has support rings 10 which are disposed on the end sides of the rotor core 5 and encase, or surround, the end windings.

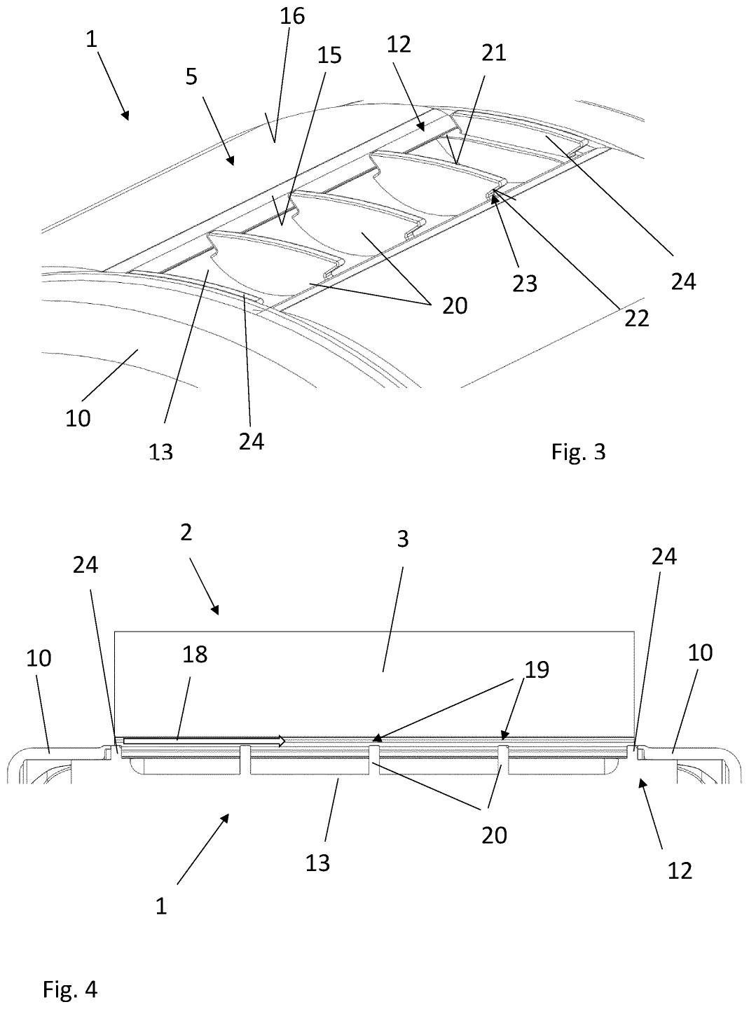

A groove 11, or pole gap, in which the winding portions of the windings of the adjacent salient poles 7 and a potting compound are disposed, is formed in each case between two adjacent salient poles 7. The salient-pole rotor 1 moreover has sliding covers 12 in order for these grooves 11 to be closed. An enlarged fragment of the salient-pole rotor 1 in the region of a sliding cover 12 is shown in FIG. 3. The sliding covers 12 have in each case one groove closure wedge 13 which has an internal side 14 facing the groove 11, and an external side 14 facing the air gap 4. The groove closure wedges 13 here are configured to be T-shaped and are supported on the pole shoes 9. The sliding covers 12 herein pushed together axially with the pole shoes 9, and in this way are connected in a form-fitting manner. To this end, the groove closure wedges 13, on lateral regions which are mutually opposite in the circumferential direction, and the pole shoes 9 have connecting elements which can be pushed into one another and by way of which a form-fitting tongue-and-groove connection is provided. The internal sides 14 of the groove closure wedges 13 can have, for example, undercuts which are not illustrated here, so that a materially integral and form-fitting connection with the potting compound filled into the grooves 11 can be established.

The external side 15 of the groove closure wedges 13 here is curved so as to be concave, while an external side 16 of the pole shoes 9 is curved so as to be convex. On account of these different curvature radii of the groove closure wedges 13 and of the pole shoes 9, an axial flow duct 17 with an enlarged flow cross section (cf. also longitudinal section of the electric machine 2 in FIG. 4) along the sliding covers 12 would be created, by way of which is guided a power loss-increasing air flow 18.

In order to provide a reduced flow cross section 19 of the flow duct 17 for the axial flow 18, a plurality of disk-type bulkheads 20 which are axially spaced apart and, proceeding from the external side 15, extend radially in the direction of the air gap 4 are disposed on the external side 15 of the groove closure wedges 13. Moreover, the bulkheads 20 additionally suppress potential transverse flows which result from the circumferential flow flux and the increments in the groove 11, thus generating a controlled formation of flux, this in turn leading to friction being minimized by way of a reduction of the turbulence energy. The bulkheads 20 are in particular configured integrally with the groove closure wedge 13. A radial height of the bulkheads 20 herein is in particular configured in such a manner that the salient-pole rotor 1 has a circular external contour in the region of the bulkheads 20. For example, an external periphery 21 of the bulkheads 20 can likewise be curved so as to be convex.

Moreover, the bulkheads 20, on lateral regions 22 which are mutually opposite in the circumferential direction, have groove-type recesses 23 in which pole shoe regions of the pole shoes 9 that project in the circumferential direction can be partially received. As a result of this design embodiment of the bulkheads 20, the bulkheads 20 partially overlap the pole shoes 9 in the circumferential direction, so that the circular external contour of the salient-pole rotor in the circumferential direction is created in the region of the bulkheads 20. Moreover, the sliding covers 12, on axially opposite ends, have radially projecting sealing faces 24 which are pressed axially onto the support ring 10.

1-10. (canceled)

11. A sliding cover for a salient-pole rotor of an electric machine, for closing a groove formed between two adjacent salient poles of the salient-pole rotor, comprising:
a groove closure wedge extending axially and in a circumferential direction, and configured to close the groove and being supported on pole shoes of the two adjacent salient poles, wherein the groove closure wedge has an internal side facing the groove and an external side facing an air gap of the electric machine; and
at least one bulkhead disposed on the groove closure wedge and, proceeding from the external side of the groove closure wedge, extends radially so as to reduce a power loss-increasing axial flow along the sliding cover in the air gap of the electric machine.

12. The sliding cover according to claim 11, comprising:
a plurality of plate-shaped bulkheads which are disposed so as to be axially spaced apart on the external side of the groove closure wedge.

13. The sliding cover according to claim 11, wherein
the external side of the groove closure wedge is curved so as to be concave.

14. The sliding cover according to claim 11, wherein
the groove closure wedge and the at least one bulkhead are integrally configured.

15. The sliding cover according to claim 11, wherein
an external periphery of the at least one bulkhead that faces the air gap is curved so as to be convex.

16. The sliding cover according to claim 11, wherein
the at least one bulkhead, on lateral regions which are mutually opposite in the circumferential direction, has groove-type recesses for partially receiving pole shoe regions of the pole shoes that project in the circumferential direction.

17. The sliding cover according to claim 11, wherein
the groove closure wedges, on lateral regions which are mutually opposite in the circumferential direction, have connecting elements for pushing together axially with pole shoe regions of the pole shoes that project in the circumferential direction, and for establishing a form-fitting connection between the sliding cover and the pole shoes.

18. A salient-pole rotor for an electric machine, comprising:
magnetic field-generating components for forming a rotor magnetic field;
a rotor core having salient poles for holding the magnetic field-generating components; and
at least one sliding cover according to claim 11.

19. The salient-pole rotor according to claim 18, wherein
an external periphery of the at least one bulkhead and an external side of the pole shoes form a substantially circular external contour of the salient-pole rotor.

20. An electric machine for a motor vehicle, comprising:
a stator; and
a salient-pole rotor according to claim 18, which is mounted so as to be rotatable relative to the stator.
